(19) United States
(12) Patent Application Publication
(10) Pub. No.: US 2022/0012286 A1
(43) Pub. Date: Jan. 13, 2022

(54) CLASSIFICATION DEVICE AND CLASSIFICATION PROGRAM

(71) Applicant: KANEKA CORPORATION, Osaka (JP)

(72) Inventors: Yoshiyuki NASUNO, Osaka-shi (JP); Satoko SHIMIZU, Osaka-shi (JP)

(73) Assignee: KANEKA CORPORATION, Osaka (JP)

(21) Appl. No.: 17/486,705

(22) Filed: Sep. 27, 2021

Related U.S. Application Data
(63) Continuation of application No. PCT/JP2020/008435, filed on Feb. 28, 2020.

(30) Foreign Application Priority Data
Mar. 29, 2019 (JP) 2019-066267

(51) Int. Cl. G06F 16/906

(52) U.S. Cl. CPC G06F 16/906

(57) ABSTRACT

A classification device enables more appropriate classification of users from various standpoints. A classification device is provided with an answer acquisition unit, a biological information acquisition unit, a determination unit, and a classification unit. The answer acquisition unit acquires, from a subject person, an answer to a prescribed question posed to the subject person. The biological information acquisition unit acquires biological information of the subject person. The determination unit determines the state of the subject person on the basis of the biological information acquired by the biological information acquisition unit. The classification unit classifies the subject person on the basis of the answer acquired by the answer acquisition unit and the state of the subject person determined by the determination unit.

### CROSS-REFERENCE TO RELATED APPLICATIONS

This application claims benefit of priority to International Patent Application No. PCT/JP2020/008435, filed Feb. 28, 2020, and to Japanese Patent Application No. 2019-066267, filed Mar. 29, 2019, the entire contents of each are incorporated herein by reference.

### BACKGROUND

### Technical Field

The present disclosure relates a classification device and a classification program.

### Background Art

In recent years, classification according to user characteristics and preferences is widely carried out in order to make the relationship between like users smoother. The results of such classification can be used in various applications. For example, a so-called businessman selects customers having good compatibility with themselves based on the results of classification, and can efficiently approach this customer having good compatibility.

An example of technology for performing such classification of users is disclosed in Japanese Unexamined Patent Application, Publication No. 2015-194849. With the technology disclosed in Japanese Unexamined Patent Application, Publication No. 2015-194849, predetermined questions such as a questionnaire are posed to the users. Then, the users are classified based on the answers of the users to these questions.

### SUMMARY

It is possible to realize classification of users, by using conventional technology such as the aforementioned technology disclosed in Japanese Unexamined Patent Application, Publication No. 2015-194849. However, classifying users more appropriately has been desired from various viewpoints, not only performing classification based on simply the responses to questions.

The present disclosure has been made taking account of such a situation. Thus, the present disclosure provides a classification system and a classification method for classifying users more appropriately from various viewpoints.

A classification device according to the present disclosure includes an answer acquisition unit which acquires from a subject person an answer to a predetermined question posed to the subject person; a biological information acquisition unit which acquires biological information of the subject person; a determination unit which determines a state of the subject person based on biological information acquired by the biological information acquisition unit; and a classification unit which classifies the subject person, based on an answer acquired by the answer acquisition unit, and a state of the subject person determined by the determination unit.

A classification program according to the present disclosure causes a computer to function as a classification device including an answer acquisition unit which acquires from a subject person an answer to a predetermined question posed to the subject person; a biological information acquisition unit which acquires biological information of the subject person; a determination unit which determines a state of the subject person based on biological information acquired by the biological information acquisition unit; and a classification unit which classifies the subject person, based on an answer acquired by the answer acquisition unit, and a state of the subject person determined by the determination unit.

According to the present disclosure, it is possible to classify users more appropriately from various viewpoints.

### BRIEF DESCRIPTION OF THE DRAWINGS

FIG. 1 is a block diagram showing an example of the overall configuration of a classification system according to an embodiment of the present disclosure;

FIG. 2 is a block diagram showing an example of the configuration of a classification device according to an embodiment of the present disclosure;

FIG. 3 is a table showing an example of a data structure of an acquired information database updated by the classification device according to the embodiment of the present disclosure;

FIG. 4 is a table showing an example of a data structure of a classification result database updated by the classification device according to the embodiment of the present disclosure;

FIG. 5 is a flowchart for explaining the flow of classification processing executed by the classification device according to the embodiment of the present disclosure; and

FIG. 6 is a flowchart for explaining the flow of matching processing executed by the classification device according to the embodiment of the present disclosure.

### DETAILED DESCRIPTION

Hereinafter, an example of an embodiment of the present disclosure will be explained by referencing the attached drawings.

### <System Configuration>

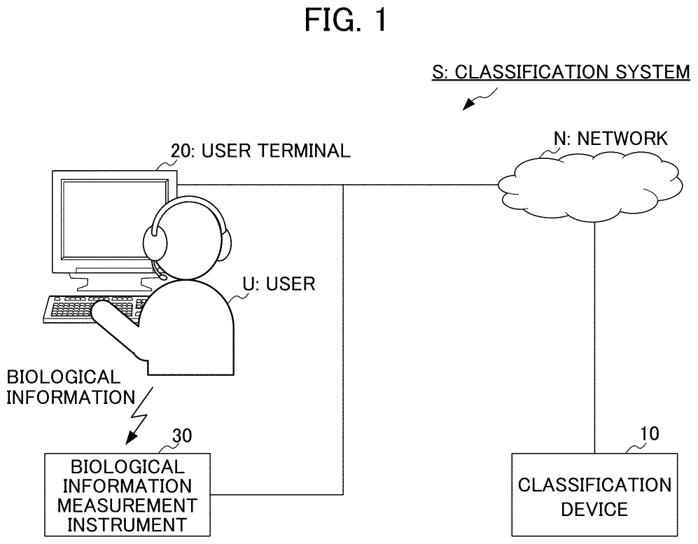

FIG. 1 is a block diagram showing the overall configuration of a classification system S according to the present embodiment. As shown in FIG. 1, the classification system S includes a classification device 10, a user terminal 20 and a biological information measurement instrument 30. In addition, FIG. 1 illustrates a user U who is a processing target of processing performed by the classification system S.

Each device included in the classification system S is connected to be able to communicate with each other via a network N in the drawings. Communication between each of these devices may be performed conforming to any communication method, and the communication method thereof is not particularly limited. In addition, the communication connection may be a wireless connection or may be a wired connection. Furthermore, communication between each of these devices may be directly performed between devices without going through a network.

The user terminal 20 and biological information measurement instrument 30 are installed at the user's home, store, etc., for example. In addition, the classification device 10 is installed in the same store as the user terminal 20, server room of an operator operating this store, etc. The business category of this store is not particularly limited, and may be a store which sells products, a store which mediates the sale, purchase, etc. of real estate, or a store which provides a matching service. This matching service, for example, may be matching between a businessman and customer having good compatibility, matching for finding friends for hobbies, etc., matching for finding a dating partner at a marriage agency or the like. In other words, the classification system S can be used in various applications regardless of the adopted application. As an example for explanation, it is assumed hereinafter that the user U is a customer, and to classify the user U who is this customer. In addition, based on these classification results, it is assumed to perform matching between a businessman and a customer having good compatibility.

The classification system S having such a configuration acquires responses from subject persons to predetermined questions posed to the subject persons (i.e. user U). In addition, the classification system S acquires biological information of the subject person. Furthermore, the classification system S determines the state of a subject person based on the acquired biological information. Then, the classification system S classifies the subject person based on the acquired responses and the state determined of the subject person. In this way, the classification system S not only performs classification simply based on the answers questions, but also performs classification based on the state of the subject person at the time of the question answering determined based on the biological information. For this reason, according to the classification system S, it becomes possible to more appropriately classify users from various viewpoints.

Next, a detailed explanation will be made for each device included in the classification system S. The biological information measurement instrument 30 measures the biological information of the user U at the time of question answering. As the measurement method, the biological information measurement instrument 30, for example, measures biological information of the user U by any of a brain wave sensor, visual line sensor, acceleration sensor, electrocardiographic sensor and Doppler sensor, or a combination of these. Herein, the brain wave sensor, visual line sensor and acceleration sensor have fast response speed compared to other sensors; therefore, they have a characteristic of being suited to measuring instantaneous changes. In contrast, the other sensors require a data collection time on the order from 10 seconds to a minute. In addition, the Doppler sensor has a characteristic of being able to measure information related to heart rate, respiration rate and body movement without contact with the body of the user U. For example, the Doppler sensor can measure the respiration rate, ratio of inhale time to exhale time, depth of motion of chest while breathing, etc. In contrast, the other sensors must be connected to the body of the user U for measurement. However, for example, the electrocardiographic sensor has a characteristic of being able to measure the heart rate variability precisely compared to the Doppler sensor.

The biosensors used in the biological information measurement instrument 30 are determined according to the characteristics of each of these biosensors and the types of biological information targeted for measurement. Hereinafter, the biological information measurement instrument 30 is assumed to measure biological information of the user U using these biosensors. For example, in the case of using the brain wave sensor, the biological information measurement instrument 30 measures the change in brain waves using a headphone-type brain wave sensor which makes electrical contact with the body at the two locations of the forehead and ear of the user U. In addition, in the case of using the electrocardiographic sensor, the biological information measurement instrument 30 measures the change in heartbeat which is one type of biological information of the user U, using a two-point contact-type electrocardiographic sensor, which touches one electrode each on both the thumbs of both hands of the user U. Furthermore, in the case of using a visual line sensor, the biological information measurement instrument 30 estimates the sight direction and/or blink, using the visual line sensor which measures electricity generated when electrodes are brought into contact with the face surface (e.g., near the nose pad of glasses) and the muscles move. Furthermore, in the case of using the acceleration sensor, the biological information measurement instrument 30 observes short, quick movement of the body, using the acceleration sensor arranged anywhere on the torso. It should be noted that, as mentioned above, these sensors may be used singly, or may be using by combining a plurality of sensors.

The biological information measurement instrument 30 generates biological information of the user U by associating the change in brain waves and change in heartrate measured by these biosensors, with the measurement time along a time series. Then, the biological information measurement instrument 30 sends the generated biological information of the user U, to the classification device 10 together with a user identifier for identifying the user U. This user identifier may be an identifier inherent (i.e. unique) to each user U, and is not particularly limited. In addition, this sending may be performed by relaying user terminals 20.

The user terminal 20 presents questions to the user U, and accepts answers of the user U to these questions. The user terminal 20, for example, can be realized by electronic equipment such as a personal computer, tablet-type terminal, and smartphone. The user terminal 20 receives questions to be asked to the user U from the classification device 10, and presents these questions to the user U. For example, they are presented by displaying question contents on a display, touch panel or the like.

In addition, the user terminal 20 accepts answers of the user U to these questions. For example, it accepts answers by operation of the user U using a keyboard and mouse, a touch panel or the like. Then, the user terminal 20 sends the accepted answers of the user U to the classification device 10, together with the user identifier for identifying the user U. It should be noted that the user identifier used is the same as the user identifier sent by the biological information measurement instrument 30. In addition, this sending may be performed by relaying the biological information measurement instrument 30.

The classification device 10 acquires the answers of the user U sent from the user terminal 20 by receiving. In addition, the classification device 10 acquires biological information of the user U sent from the biological information measurement instrument 30 by receiving. Furthermore, the classification device 10 characterizes the state of the user U during question answering, by performing determination based on the acquired biological information of the user U. Then, the classification device 10 classifies the subject person based on the acquired answers and state determined of the subject person.

Additionally, the classification device 10 performs matching based on the classification results, in response to the request of the matching applicant (herein, a businessman desiring matching with a user U who is a customer, as mentioned above) desiring matching with the user U. Then, the classification device 10 presents the matching results to the matching applicant in list form, for example. The classification device 10, for example, can be realized by electronic equipment such as a server device, personal computer or the like.

By each device cooperating as explained above, the classification system S functions as a system which performs appropriate classification, and enables matching based on the appropriate classification.

An explanation has been provided above for each device included in the classification system S. It should be noted that, although each device is illustrated one for one in the drawings, this is merely an exemplification, and each of these devices may be included in any number in the classification system S. For example, a group of the user terminal 20 and the biological information measurement instrument 30 may be provided in a plurality of groups corresponding to a plurality of users U. Then, for example, it may be configured so as to collectively perform each type of processing for this plurality of groups by one classification device 10. In addition, for example, the user terminal 20 and biological information measurement instrument 30 may be realized as an integrated device, without being realized as separate devices. In addition, in this case, the classification device 10, user terminal 20 and biological information measurement instrument 30 may be further realized as an integrated device.

### <Configuration of Classification Device>

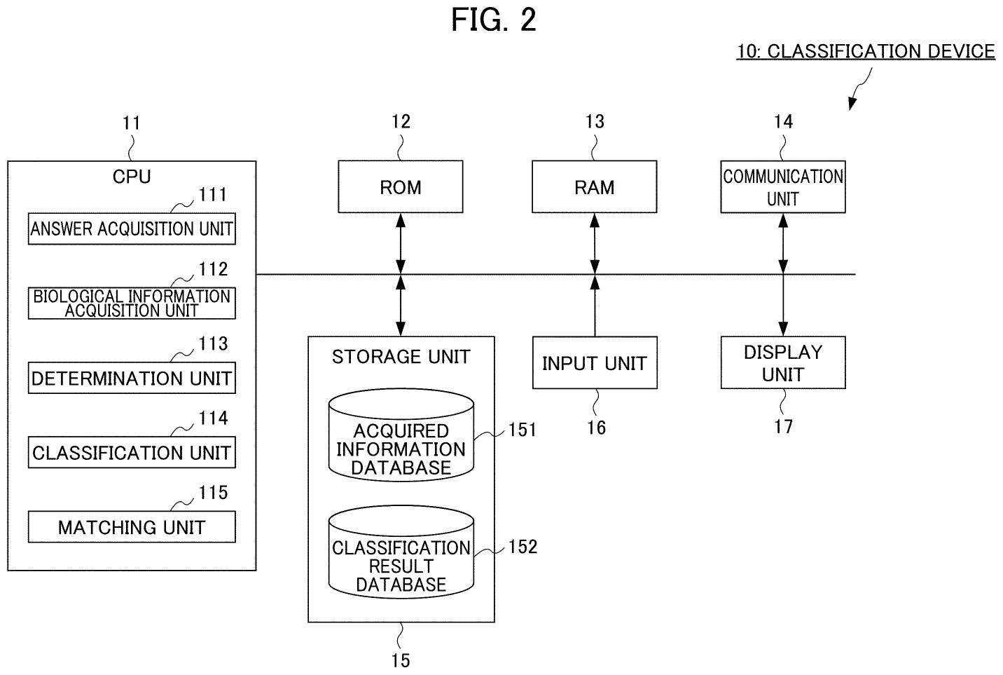

Next, an explanation is made for the configuration of the classification device 10 by referencing the block diagram of FIG. 2. As shown in FIG. 2, the classification device 10 includes a CPU (Central Processing Unit) 11, ROM (Read Only Memory) 12, RAM (Random Access Memory) 13, communication unit 14, storage unit 15, input unit 16 and display unit 17. Each of these parts is bus connected by signal wire, and send/receive signals with each other.

The CPU 11 executes various processing in accordance with programs recorded in the ROM 12, or programs loaded from the storage unit 15 into the RAM 13. Data, etc. required upon the CPU 11 executing the various processing is stored as appropriate in the RAM 13.

The communication unit 14 performs communication control for the CPU 11 to perform communication with other devices (e.g., user terminal 20 and biological information measurement instrument 30). The storage unit 15 is configured by semiconductor memory such as DRAM (Dynamic Random Access Memory), and stores various data.

The input unit 16 is configured by external input devices such as various buttons and a touch panel, or a mouse and keyboard, and inputs various information in response to instruction operations of the user. The display unit 17 is configured by a liquid crystal display or the like, and displays images corresponding to image data outputted by the CPU 11.

The classification device 10 performs “classification processing” and “matching processing” by each of these units cooperating. Herein, classification processing is a series of processing for more appropriately classifying users from various viewpoints, by the classification device 10 performing classification based on the answers of the user U and state of the user U determined from the biological information of the user U. In addition, matching processing is a series of processing for the classification device 10 performing matching based on appropriate classification results from the classification processing, and presenting the matching results to the matching applicant.

In the case of each of these types of processing being executed, the answer acquisition unit 111, biological information acquisition unit 112, determination unit 113, classification unit 114 and matching unit 115 function in the CPU 11, as shown in FIG. 2. In addition, an acquired information database 151 and classification results database 152 are stored in an area of the storage unit 15. Including cases not particularly mentioned below, the data required to realize the respective processing is appropriately transmitted at the suitable timing between these functional blocks.

The answer acquisition unit 111 acquires the answers of the user U sent from the user terminal 20 by receiving. Then, the answer acquisition unit 111 stores the acquired answers of the user U in the acquired information database 151. In addition, as a premise of this, the answer acquisition unit 111 stores the questions to the user U in the storage unit 15, etc., and sends the questions to the user U to the user terminal 20.

The biological information acquisition unit 112 acquires the biological information of the user U sent from the biological information measurement instrument 30 by receiving. Then, the biological information acquisition unit 112 stores the acquired biological information of the user U in the acquired information database 151.

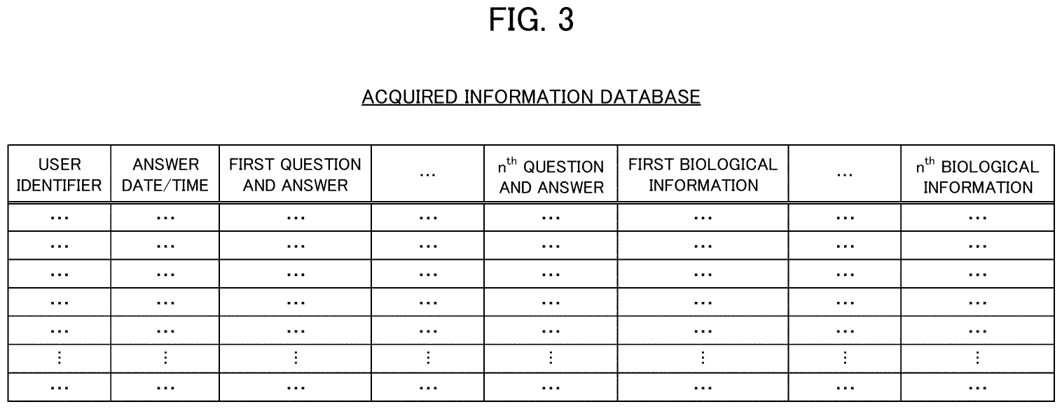

Herein, the acquired information database 151 is a database in which various information used for the classification device 10 to perform classification processing is stored. An example of the specific data structure of the acquired information database 151 will be explained by referencing FIG. 3.

As shown in FIG. 3, in the acquired information database 151, various information associated with the user identifier is stored as one record. For example, information corresponding to a question group of one set including n-number of consecutive questions (n is any natural number) is stored as one record.

In addition, there are also cases where a plurality of records is stored for the same user U. For example, in the case of asking questions using a plurality of sets of question groups for which the contents of questions differ from each other, each set of information corresponding to each set of question groups is stored as a plurality of records for the same user U. Alternatively, for the same user U, the situation in which performing questioning (e.g., location, time, etc. of performing questioning) may be made to differ, and in the case of posing questions using the same question group a plurality of times, each set of information corresponding to each time is stored as a plurality of records.

Each record includes, as columns, for example, “user identifier”, “measurement time/date”, “first question and answer” to “n^{th} question and answer”, and “first biological information” to “n^{th} biological information”. An explanation will be made for the specific contents of information corresponding to each of these columns.

“User identifier” is an identifier for identifying the user U corresponding to each record. As mentioned above, the user identifier may be any information so long as being an identifier unique for each of the respective users U. For example, the ID (Identifier) allocated based on a predetermined rule may be defined as the user identifier.

“Question date/time” is information indicating the date/time at which a question corresponding to this record was posed. For example, “question date/time” is information of a time from when questioning according to one set of a question group including n-number of consecutive questions was started until finished.

“First question and answer” to “n^{th} question and answer” is a group of questioning performed by the user terminal 20 and the answer thereto accepted from the user terminal 20. The contents of questions and the answer method are not particularly limited, and various options can be selected according to the application adopting the present embodiment. For example, the question may be a questionnaire for understanding the characteristics and preferences of the user U, and the answer method may be a method whereby the user U selects from options prepared in advance.

“First biological information” to “n^{th} biological information” is biological information measured by the biological information measurement instrument 30, and is stored to be associated with questions. In other words, the biological information measured upon the first question and response thereto being performed becomes first biological information. It should be noted that the stored biological information is “brain wave”, “heart rate”, “respiratory rate”, “respiration depth”, etc., as mentioned above. Such an acquired information database 151 is updated by the answer acquisition unit 111 and biological information acquisition unit 112, every time questioning to the user U and an answer thereto from the user U are performed.

The determination unit 113 specifies the condition of the user U during question answering, by performing determination based on the biological information of the user U stored by the biological information acquisition unit 112 in the acquired information database 151. As the state, for example, it determines the state suited to the objective of performing classification, such as a state of comfort, excitement, emotion, mood, etc. For example, in the case of performing determination based on the brain waves obtained as biological information of the user U, the brain waves are subjected to Fourier transformation to perform frequency resolution. Then, it is possible to determine the condition of the user U based on the results of frequency resolution, and criteria such as <Determination Criteria based on Frequency> below.

### <Determination Criteria Based on Frequency>

Theta (4-7 Hz)

When the ratio of the theta wave is high, deep relaxed state, light sleep state

Alpha Low (8-9 Hz): state of consciousness not suited to outside world

When ratio of alpha wave is high, state of mental and physical calm

Alpha High (10-12 Hz): open awareness state, state that can handle wide range of situational changes

Beta Low (13-17 Hz): problem solving state

When ratio of beta wave is high, active thinking and concentration state
State when nervous or having some stress

Beta High (18-30 Hz): relation to emotional strength (including both positive and negative)

Gamma Low (31-40 Hz):

When ratio of gamma wave is high, state of strong relationship to perception and consciousness, particularly high mental activity (association with plurality of matters) State of strong anxiety, excited state (not limited to negative)

It should be noted that the above-mentioned <Determination Criteria based on Frequency> is an example for performing determination, and may perform determination based on other criteria, or by combining other criteria. For example, it is determined whether or not the parasympathetic nerve is predominant based on the heart rate. Herein, the frequency components of the high frequency band when power spectrum analyzing the frequency components of the cyclic change in heart rate (e.g., from 0.20 Hz to 0.15 Hz) are greater compared to other frequency components, it is possible to determine that the parasympathetic nerve is predominant. Then, it may be configured so as to determine that many alpha waves are appearing among the brain waves, and the state of the parasympathetic nerve is predominant as a state of high comfort. Otherwise, for example, in a case of performing determination based on the sight direction and/or blink according to the visual line sensor, it is possible to determine as states such as degree of concentration and degree of sleepiness of the user U, based on the sight direction and/or blink. Moreover, for example, in the case of performing determination based on short, quick movement of the body observed by the accelerometer, it is possible to determine conditions such as the nervousness and anxiety of the user U, based on the short, quick movement of the body.

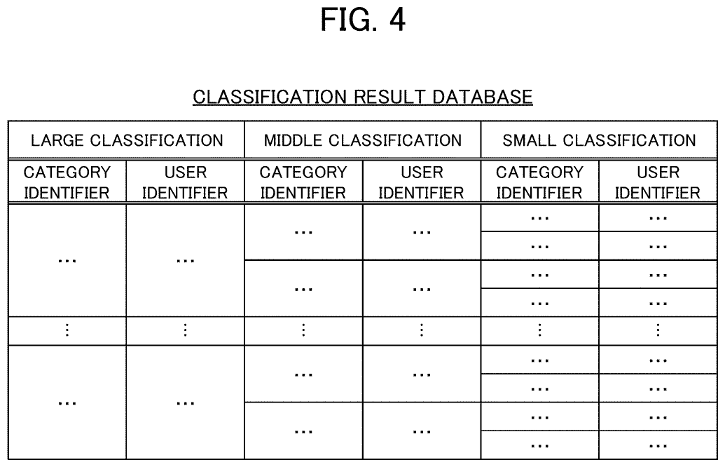

The classification unit 114 classifies the user U, based on the responses of the user U stored by the answer acquisition unit 111 in the acquired information database 151, and the condition of the user U during question answering determined by the determination unit 113. Then, the classification unit 114 stores the classification results in the classification result database 152. As a premise of classification of the classification unit 114, first the classification result database 152 will be explained. Herein, the classification result database 152 is a database in which classification results from the classification unit 114 are stored. An example of the specific data structure of the classification result database 152 will be explained by referencing FIG. 4.

As shown in FIG. 4, as an example of categories for classifying the user U, categories corresponding to the three classifications of “large classification”, “middle classification” and “small classification” are provided in the classification result database 152. Herein, the user U is first classified in the category of the large classification in the classification. In addition, the user U is also classified into the category of the middle classification, which is a classification further subdividing the large classification. Furthermore, the user U is also classified into the category of small classification, which is a classification further subdividing the middle classification. In this way, the categories classifying the user U are provided hierarchically so as to be further subdivided every time following the hierarchy. Each classification includes “category identifier” and “user identifier” as columns, for example. An explanation will be made for the specific contents of information corresponding to each of these columns.

“Category identifier” is an identifier for identifying each category. The category identifier may be any information so long as being an identifier unique for each of the respective categories, similarly to the user identifier. For example, the name indicating the characteristic of the category may be defined as the category identifier.

“User identifier” is an identifier of the user U classified relative to each classification by the classification unit 114. The identifier itself used as the user identifier is the same as the identifier used as the user identifier in the acquired information database 151. Such a classification result database 152 is updated by the classification unit 114, every time questioning to the user U and an answer thereto by the user U are performed.

As the specific classification method, first the classification unit 114 performs weighting on answer of the user U for the corresponding question, based on the state of the user U at the time of question answering determined by the determination unit 113. For example, based on the state of the user U during the first question answering determined based on the first biological information, weighting is performed on the answer to the first question. For example, in the case of the determined state of the user U during the question answering being a deep relaxed state or state of mental and physical calm, the user U is considered to be responding without hesitation, responding sincerely, and responding the truth based on past truths. In other words, the credibility of this response is considered high. Therefore, the classification unit 114 increases the weighting so that the influence imparted by this answer on classification is greater in such a case.

In contrast, for example, in the case of the determined state of the user U during question answering being a state not a relaxed state, or state when nervous or having some stress, it is considered that the user U is responding with hesitation, not responding sincerely, responding by imagining a fictitious answer, or making a false response. In other words, the credibility of this answer is considered low. Therefore, the classification unit 114 lessens the weighting so that the influence imparted by this answer on classification is smaller in such a case.

The classification unit 114 classifies the user U into the respective categories of large classification, middle classification and small classification, by configuring so that the influence of answers having heavy weight increases based on answers imparted weight in this way. It should be noted that the classification unit 114, after performing weighting based on information corresponding to the one set a question group including n-number of consecutive questions, in the case of information corresponding to a separate question group for the same user U being added, performs classification again based on information for all of the question groups thus far for this user U. In this case, it may be configuring so as to increase the weighting for the latest question group, so that the influence is greater for information of the latest question group.

In this way, the classification device 10 not only performs classification based on simply on the answer to a question, but also performs classification based on the condition of a subject person during question answering determined based on the biological information. For this reason, according to the classification device 10, it becomes possible to more appropriately classify the user from various viewpoints.

The matching unit 115 performs matching based on the classification results, in response to a request of a matching applicant (herein, a businessman desiring matching with a user U who is a customer, as mentioned above) who desires matching with users U. Then, the classification unit 10 presents the matching results in list format to the matching applicant, for example. Hereinafter, as an example for explanation, a case is assumed of presenting a list format in which a plurality of the users U matched to the matching applicant (hereinafter called “matching partner”) is included.

The matching unit 115 first accepts an operation by the input unit 16, or a matching request from the matching applicant, by communication from another device (e.g., any user terminal 20) via the communication unit 14. In this case, the matching unit 115, for example, accepts the selection of attributes of candidates for a matching partner, from the matching applicant. The attributes, for example, may be the sex, age, etc. of candidates to be matching partners, or may directly indicate the classification of the candidates for a matching partner.

The matching unit 115 determines candidates for matching partner to be included in the list, based on this selected attribute. In this case, the matching unit 115 may be configured so as not to include only the matching partners corresponding to the selected attribute itself, but also give some latitude to the selected attribute, and also include in the list the matching partners corresponding to attributes given this latitude. For example, it may be configured so as to give latitude so as to also include an attribute resembling the selected attribute, and include matching partners corresponding the attribute given this latitude.

It should be noted that, for the attributes of each user U, for example, it may be configured to have the user U input attributes during question answering, etc., and store in the storage unit 15, etc. Alternatively, in the case of performing membership registration or the like in a store, etc., it may be configured so as to obtain consent from the user U, and reappropriate the attribute inputted during this membership registration, etc.

The matching unit 115 first extracts, from the classification result database 152, the users U who are candidates to be included in the list, based on this selected attribute. Then, the matching unit 115 performs matching based on the extracted classification results (i.e. classified categories) of the user U. As the method of matching, for example, the matching unit 115 specifies the category to which the matching applicant is classified, and defines as matching partners the users U of the same category as the category of this matching applicant. Alternatively, users U of a category considered to have good compatibility with the category of this matching applicant are defined as matching partners.

As the method of specifying the category of the matching applicant, upon the matching applicant performing a matching request, their own category may be inputted. For example, in the case of a businessman or the like who is a person performing predetermined promotion, the category of the matching applicant may be specified in this way. Alternatively, in the case of the matching applicant themselves also being one of the users U, it may be configured so as to specify the category of the matching applicant, based on the results of the classification processing of the classification device 10. For example, in a case such that members of a marriage agency or the like (each corresponding to users U) performing matching, it may specify the category of the matching applicant in this way.

In addition, the matching unit 115 not only simply does matching, but may be configured so as to also calculate index values (hereinafter called “matching suitability value”) indicating the suitability of matching. In this case, for example, the matching unit 115 raises the matching index value of the matching partner who agrees in the same category as the category of the matching applicant (or category considered to have good compatibility), and who agrees in the category of small classification. In addition, the matching unit 115 lowers from this the matching index value of the matching partner who does not agree in the category of small classification, but agrees in the category of middle classification. Furthermore, the matching unit 115 lowers by the most the matching index value of a matching partner who does not agree in the categories of the small classification and middle classification, and only agrees in the category of the large classification.

Then, the matching unit 115 presents to the matching applicant as a matching list by collecting in list format the matching partners determined in this way and the matching index value of each matching partner. The presentation, for example, is realized by display of the matching list on the display unit 17, or printing the matching list on paper media. It should be noted that the matching unit 115 may be configured so as to send information, etc. of the matching applicant to the user terminal 20 used by the user U having become a matching partner.

In addition, in this case, the matching unit 115 may further present recommendation information for the matching applicant to come into contact with the matching partner, for every respective matching partner included in the matching list. The recommendation information, for example, may be defined as information for further smoothing the connection with the matching partner such as a specific keyword (e.g., what should be said, or what should not be said), timing of connecting (e.g., timing at which to cast a specific keyword), based on the attribute of the matching partner.

The matching applicant may not only grasp the matching partner, but can also know values for matching suitability value indicating the suitability of a matching partner, and recommendation information for connecting with the matching partner, by referencing this presented information. It thereby not only enables matching based on appropriate classification by the classification processing, but also becomes possible to give useful information for selecting the final matching partner and smooth the connection with the matching partner for the matching applicant.

### <Classification Processing>

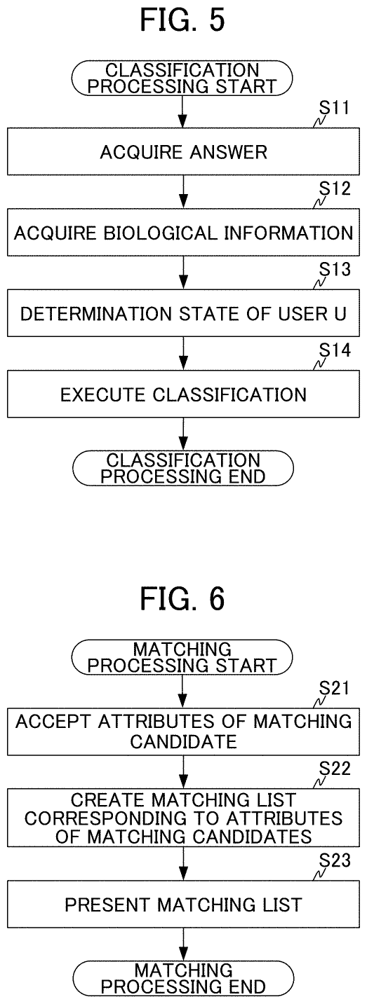

Next, the flow of classification processing executed by the classification device 10 will be explained by referencing the flowchart of FIG. 5. The classification processing is executed accompanying the start of questioning to the user U.

In Step S11, the answer acquisition unit 111 acquires answers of the user U. In Step S12, the biological information acquisition unit 112 acquires biological information of the user U. In Step S13, the determination unit 113 determines the state of the user U. In Step S14, the classification unit 114 executes classification. This processing thereby ends.

According to the classification processing explained above, classification is performed based not only on merely the answers to questions, but classification is also performed based on the state of the subject person during question answering determined based on the biological information. For this reason, according to the classification system S, it becomes possible to more appropriately classify users from various viewpoints.

### <Matching Processing>

Next, the flow of matching processing executed by the classification device 10 will be explained by referencing the flowchart of FIG. 6. The matching processing is executed accompanying a matching request operation by a matching applicant.

In Step S21, the matching unit 115 accepts attributes of matching candidates from the matching applicant. In Step S22, the matching unit 115 creates a matching list corresponding to the attributes of matching candidates accepted in Step S21. In Step S23, the matching unit 115 presents the matching list. This processing thereby ends.

It becomes possible to give useful information to the matching applicant, and not only enable matching based on appropriate classification by the classification processing explained above.

### MODIFIED EXAMPLES

Although an embodiment of the present disclosure has been explained above, this embodiment is merely an exemplification, and is not to limit the technical scope of the present disclosure. The present disclosure can assume various other embodiments, and various modifications such as omissions and substitutions can be performed within a scope not departing from the gist of the present disclosure. These embodiments and modifications thereof are encompassed in the scope and gist of the disclosure described in the present disclosure, and encompassed in the scope of the disclosure and equivalents thereto described in the claims. For example, embodiments of the present disclosure may be modified as in the following modified examples.

### First Modified Example

In the aforementioned embodiment, the answer acquisition unit 111 stores the questions to the user U in the storage unit 15, etc., and sends the questions to the user U to the user terminal 20. Then, the user terminal 20 receives these questions, and presents the questions to the user U. In this case, the answer acquisition unit 111 may be configured so as to determine the contents of questions newly posed to the user U, based on the results of performing classification processing once.

For example, in the case of the user U being classified to a certain category, there is a possibility that the user U should be classified not to this certain category, but actually to another category resembling this certain category. Therefore, in such a case, it is preferable to establish the contents of the questions newly posed to the user U as contents such that can divide as should be classified into this certain category, or should be classified to another category. In this way, based on the results of performing the classification processing once, it is possible to perform classification with higher precision, by determining the contents of questions newly posed to the user U.

### Second Modified Example

In the aforementioned embodiment, the matching unit 115 determined the matching partner based on the classification results by the classification processing. Not limiting to this, it may be configured so as to determine a matching partner also based on respective information used by the classification unit 114 in order to perform classification. For example, it may be configured so as to determine a matching partner using the answer itself of the user U used by the classification unit 114 in order to perform classification, or the biological information itself at the time of answering by the user U. For example, the matching unit 115 may be configured so as to select, as a matching partner, the user U having the same answers as the matching applicant, or the user U having biological information such that is the same as the biological information at the time of answering of the matching applicant. Alternatively, the matching unit 115 may be configured so as to raise the matching index value of such a user U.

### Third Modified Example

In the aforementioned embodiment, the classification unit 114 performed classification based on the answer of the user U, or state at the time of answering of the user U determined from the biological information at the time of answering of the user U. Not limiting to this, other than the answering time, it may be configured so as to perform classification based on the state of the user at another time than determined from the biological information of another time.

For example, it may be configured so as to perform classification based on also the state of the user U at the time of contents experience for experience determined from the biological information during experience of the contents for experience using virtual reality (VR: Virtual Reality). In this case, for example, the user U wears a device of goggle type or the like providing virtual reality. Then, by this goggle-type device, the experience contents are made to be experienced by the user U. In addition, similarly to at the time of question answering, the biological information of the user U is measured by the biological information measurement instrument 30. Then, based on this biological information, the determination unit 113 determines the state of the user U.

By also basing on the state of the user U in the case of an unrealistic situation, it is possible to clarify a characteristic of the user U such that the user U themselves was not aware. For this reason, the classification unit 114 becomes able to perform classification more in accordance with the characteristics of the user U.

It should be noted that the modified examples may be further modified to realize the biological information measurement instrument 30 by the goggle-type device which provides virtual reality. For example, the biological information measurement instrument 30 may be realized by combining sensors with this goggle-type device. It is thereby possible to measure biological information without the user being conscious of wearing sensors.

### <Realization by Hardware, Software, Etc.>

Each device included in the aforementioned embodiment is not limited to the form of the aforementioned embodiment, and can be realized by general electronic equipment having an information processing function. In addition, the aforementioned series of processing can be executed by hardware, or can be executed by software. In addition, one functional block may be configured by a single hardware unit, may be configured by a single piece of software, or may be configured by a combination of these. In other words, the functional configurations illustrated in FIG. 2 are merely exemplifications, and are not limited thereto. In other words, it is sufficient if a function which can execute the aforementioned series of processing as a whole is provided to the classification system S, and which functional block is used in order to realize this function is not particularly limited to the example of FIG. 2.

For example, the functional configurations included in the present embodiment can be realized by a processor which executes arithmetic processing, and the processors which can be employed in the present embodiment include, in addition to those configured by various processing devices singularly such as a single processor, multiple processor and multi-core processor, a processor in which these various processing devices and processing circuits such as ASIC (Application Specific Integrated Circuit) or FPGA (Field-Programmable Gate Array) are combined.

In the case of executing a series of processing by software, the programs constituting this software is installed in a computer or the like from a network or recording medium. The computer may be a computer built into dedicated hardware. In addition, the computer may be a computer capable of executing various function, for example, a general-purpose personal computer, by installing various programs thereto.

The recording medium containing such programs may be provided to the user by being distributed separately from the device main body in order to provide the programs to the user, or may be provided to the user in a state incorporated into the device main body in advance. The recording medium distributed separately from the device main body is configured by a magnetic disc (including floppy disc), optical disc, magneto-optical disc or the like. An optical disc, for example, is constituted by CD-ROM (Compact Disc-Read Only Memory), DVD (Digital Versatile Disc), Blu-ray (registered trademark) Disc (Blu-ray) or the like. A magneto-optical disc is constituted by MD (Mini-Disc) or the like. In addition, the recording medium provided to the user in a state incorporated into the device main body in advance is constituted, for example, by the ROM 12 of FIG. 2 on which the programs are records, or a hard disk included in the storage unit 15 of FIG. 2, for example.

It should be noted that, in the present disclosure, the steps defining the program recorded in the storage medium include not only the processing executed in a time series following this order, but also processing executed in parallel or individually, which is not necessarily executed in a time series. In addition, in the present specification, a term system shall mean a general device configured from a plurality of devices, a plurality of means, and the like.

What is claimed is:

1. A classification device comprising:
an answer acquisition unit configured to acquire from a subject person an answer to a predetermined question posed to the subject person;
a biological information acquisition unit configured to acquire biological information of the subject person;
a determination unit configured to determine a state of the subject person based on biological information acquired by the biological information acquisition unit; and
a classification unit configured to classify the subject person, based on an answer acquired by the answer acquisition unit, and a state of the subject person determined by the determination unit.

2. The classification device according to claim 1, wherein
the answer to the predetermined question is weighted as information used in classification, based on the state of the subject person determined by the determination unit.

3. The classification device according to claim 1, wherein
the biological information acquired by the biological information acquisition unit is biological information measured from the subject person during answer to the predetermined question by the subject person.

4. The classification device according to claim 1, wherein
the biological information acquired by the biological information acquisition unit is biological information measured from the subject person during experience of experience contents by the subject person.

5. The classification device according to claim 4, wherein
the experience contents are contents which can be experienced by the subject person wearing a device providing virtual reality, and
the biological information acquisition unit is configured to acquire biological information measured by the device providing virtual reality.

6. The classification device according to claim 4, wherein
the classification unit is configured to classify the subject person, further based on details of the experience contents.

7. The classification device according to claim 1, wherein
the answer acquisition unit is configured to determine details of the predetermined question newly posed to the subject person, based on classification results of the classification unit.

8. The classification device according to claim 1, further comprising:
a matching unit configured to determine a matching partner who matches with the subject person, based on classification results of the classification unit.

9. The classification device according to claim 8, wherein
the matching unit is configured to determine the matching partner based on each set of information used by the classification unit to perform classification.

10. The classification device according to claim 8, wherein
the matching partner is a person who performs predetermined promotion to the subject person with the subject person as a customer.

11. The classification device according to claim 8, wherein
the matching partners are subject persons.

12. The classification device according to claim 8, wherein
the matching unit is configured to determine a person classified into a category identical to the subject person as the matching partner.

13. The classification device according to claim 12, wherein
the category classifying the subject person is hierarchically provided so as to be further subdivided every time following a hierarchy, and
the matching unit is configured to determine, as a matching partner having higher matching suitability, a person classified into an identical category in a further subdivided hierarchy.

14. The classification device according to claim 8, wherein
the matching unit is configured to calculate an index value of matching propriety with each of the matching partners, and present the index value thus calculated to the target user as a list.

15. The classification device according to claim 14, wherein
the matching unit is further configured to present, to the subject person, recommendation information for the subject person to connect with the matching partner, for each of the matching partners included in the list.

16. The classification device according to claim 14, wherein
the matching unit is configured to accept, from the subject person, a selection of an attribute of a candidate to be a matching partner, and determine a matching partner to be included in the list, based on the selected attribute.

17. The classification device according to claim 2, wherein
the biological information acquired by the biological information acquisition unit is biological information measured from the subject person during answer to the predetermined question by the subject person.

18. The classification device according to claim 2, wherein
the biological information acquired by the biological information acquisition unit is biological information measured from the subject person during experience of experience contents by the subject person.

19. The classification device according to claim 5, wherein
the classification unit is configured to classify the subject person, further based on details of the experience contents.

20. A computer-readable medium of instructions including a classification program which causes a computer to function as a classification device, the classification device comprising:
an answer acquisition unit configured to acquire from a subject person an answer to a predetermined question posed to the subject person;
a biological information acquisition unit configured to acquire biological information of the subject person;
a determination unit configured to determine a state of the subject person based on biological information acquired by the biological information acquisition unit; and
a classification unit configured to classify the subject person, based on an answer acquired by the answer acquisition unit, and a state of the subject person determined by the determination unit.
